(19) United States
(12) Patent Application Publication
(10) Pub. No.: US 2008/0271587 A1
(43) Pub. Date: Nov. 6, 2008

(54) Fret Dressing Mask

(76) Inventor: John Ames Cross, Van Nuys, CA (US)

Correspondence Address: AARON PAUL MCGUSHION, 16470 HARBOUR LANE, HUNTINGTON BEACH, CA, 92649, US

(21) Appl. No.: 11/743,898

(22) Filed: May 3, 2007

(51) Int. Cl. G10D 3/06

(52) U.S. Cl. 84/314 R

(57) ABSTRACT

Fret Dressing Masks: In the manufacturing of guitars and other fretted stringed instruments, it is necessary to file level, after installation, the 20 or more metal frets which are inserted across the wood neck. This is not a job which can be performed by machines and requires the hand work of instrument craftsmen. To accomplish this operation without damaging the neck of the instrument, several layers of paper masking tape have historically been applied. This is a time consuming, expensive process. Fret Dressing Masks are a disposable tool, approximately twenty-two inches long, cut from thick vinyl, and have slots/windows-cut and registered to fit around the frets. In one motion, they are applied to protect the neck instead of masking tape. This process takes less than two minutes, which is one tenth of the time of the current task. Once the filing process is complete, the Fret Dressing Masks can be removed in seconds. Thirty or more minutes total can be saved in the manufacturing of fretted instrument necks, thus saving time and labor costs.

### DESCRIPTION OF THE INVENTION

The “Fret Dressing Mask” is a tool which will be used in the manufacturing of fretted necks of instruments, such as guitars, banjos, and kimbundus, as well as other stringed instruments which also utilize a fretted neck. “Fret Dressing Masks” are made of a vinyl material which have slots/windows that fit tightly next to the metal frets when the dressing is placed on a guitar neck. The Fret Dressing Masks self adheres to the guitar neck during manufacturing to protect the wood during tooling. Fret Dressing Masks can vary in size, but the majority will be approximately 22 inches long and taper from 2¾ inches wide at the top, to 3½ inches at the bottom. This is of a size which extends beyond and overlays the guitar neck on both ends and each side. There is also the option to roll the overhang vinyl and adhere to the back side of the neck for further wood protection.

Twenty to twenty four frets are placed on a guitar neck. The top fret spacing is usually 1¼ inches between frets, growing progressively closer down the neck, ending with the bottom spacing close to 5/16 inches. Spacing from one instrument model to the next can vary slightly.

Slots/windows: Slots/windows are cut into the Fret Dressing Mask vinyl during fabrication, which allows the frets to protrude through the Fret Dressing Mask when it is applied to the neck. The overall dimensions of the Fret Dressing Mask will remain the same for all instruments, but fret numbers, sizes, and spacing vary from one instrument model to the next. Because an exact fit is necessary for accurate tooling, Fret Dressing Mask slots/windows must be tailored to the specific model of guitar or instrument.

Manner and process: Fret Dressing Masks are fabricated from an adhesive backed four millimeter thick vinyl and are cut on a computer controlled machine specifically designed for cutting sheet vinyl. This vinyl was developed and is produced for use as backing of graphics and signs. As stated above, the overall dimension of the Fret Dressing Masks remain the same, and the tailoring of fret slots/windows dimensions and positioning is accomplished within the computer program for the specific instrument run.

Using Fret Dressing Masks: In the manufacturing of guitars and similar fretted stringed instruments, the neck assembly is completed before attachment to the body. This process includes hand filing frets to a level plane. To accomplish this without damaging the wood of the neck, the Fret Dressing Mask is placed on the completed neck, thus covering and protecting the wood, yet leaving the frets exposed for tooling. With the Fret Dressing Mask in place, the guitar craftsman, (known in the industry as a “Luthier”) can then file the frets without scaring the expensive wood, usually rose or ebony. Installation of the Fret Dressing Mask takes less than two minutes and removal takes about one minute. Application and removal time is about 10 percent of the existing method. As production of instruments can run in to the thousands, the labor savings is considerable.

### BACKGROUND

### Field of Endeavor

Fretted stringed instrument manufacturing has evolved through the centuries from a hand made process, where the craftsman fabricated the instrument one at a time from beginning to end. It was a hand operation and the filing of the frets* was an integral part of the hand fabrication. The American guitar and instrument manufacturing industry still is inhabited by hundreds of small shops, but the demand for new models and specialty guitars has far outrun the small manufacturers ability to satisfy buyers needs. Larger manufacturing companies have come to dominate the market and produce large quantities of instruments on assembly line facilities, incorporating automated wood working machinery, metal fabrication, plating facilities and production painting with waterfall operations. Luthiers, however, are still required to do the hand filing/leveling of the frets after they have been inserted into the wood neck.

The fret filing operation: Fret filing is a process where metal frets are filed after being installed into the neck of the instrument. The intent of this process is to precisely level all frets in relation to the adjoining frets. Visualize the process as a road grader on a gravel road, which is a long vehicle with a leveling tool in the middle. Filing is done with strokes running the length of the neck, while the file itself, is held long way, or parallel to the neck. In this manner, the high spots and the low spots of the twenty some frets are smoothed out to a perfectly level plane. This is necessary so the instrument will play most efficiently and stay in good harmonic tune.

*Frets: Narrow metal bars embedded across the wood neck of stringed instruments. When the musician fingers a string on different frets, it produces desired notes.

The fret filing is one of the responsibilities of the Luthier, even on a huge production line. As a hand operation, it is time consuming, but a big part of that time is masking the wood of the neck between each of the frets. This operation alone takes twenty to thirty minutes as it requires several layers of masking tape.

Unlike masking for the spray painting process, fret masking requires protection from the damage which can be caused by the tools used in the filing process. At this point, a great deal of labor and high quality materials have already gone into the neck. Damage, while filing, would result in an unusable neck, thus disruption to the production process.

Up to this point, the search for an improved method, by instrument manufacturers, has been without success. It is important for the industry to find ways to expedite the fret filing operation to speed up the production lines.

### BRIEF SUMMARY

General idea: This product will be provided to the final user as a precut vinyl mask with a non permanent adhesive backing, which is applied to the neck of the instrument prior to fret filing. This vinyl mask has slots/windows which are in register with the frets and when applied to the neck, it leaves them exposed for the filing process. Precut Fret Dressing Masks have a high accuracy of fit to protect the guitar neck during the filing process.

Solution of existing problem: Masking with paper tape, as done presently by hand, is an extremely time consuming part of neck manufacturing. Fret Dressing Masks solve that problem. The hand process can not be any quicker, as care is necessary to avoid damage which would be caused by the tools in the filing process.

The object of Fret Dressing Masks: Fret Dressing Masks can be installed in about two minutes and produce a ten fold savings of time, thus greatly reducing labor costs.

### DESCRIPTION OF SEVERAL VIEWS ATTACHED TWO PAGES OF DRAWINGS

Fret Dressing Mask design: Page 9, FIG. 1A. The design of the Fret Dressing Mask is shown in this overhead view. The vinyl from which Fret Dressing Masks are cut is a maximum of eight millimeters thick, therefore there are no side views.

Elements of the illustration:
a. Top fret spacing: This starts with a wide space of about 1¼ inches, though dimensions may vary slightly from one model to the next. Spacing then grows narrower as the frets progress down the neck of the instrument.
b. The outline: The dressing is shown in heavy lines and tapers from 2¾ inches at the top, to 3½ inches at the bottom. Outer dimensions are not critical, but remain the same for ease of manufacturing (Standard guitar necks are approximately 22 inches long and bass guitars are customarily 25 inches long).
c. Slots/Windows: The slots/windows are cut in the vinyl to register with the frets of the instrument neck to which the Fret Dressing Masks will be applied.
d. Dotted lines: The vertically dotted lines shown in the illustration indicate the position of the instrument neck when Fret Dressing Masks are adhered for tooling.
e. Fret spacing: Fret spacing at the bottom is much narrower than the top and may also vary slightly.

FIG. 2A. Application of the Fret Dressing Masks to the instrument neck. Application takes two to three minutes. After first removing the paper backing, the first fret is positioned in the respective window, then the other frets fall into place with finger pressure to stick the Fret Dressing Masks down to the instrument neck.

FIG. 2B. Filing of frets. The Fret Dressing Masks is designed larger to overhang the sides and the ends of the neck. Once the Fret Dressing Mask is adhered, filing is accomplished using a medium file (shaded color on illustration). Once leveled, the frets are then buffed to complete the tooling operation.

FIG. 2C. Removal of the Fret Dressing Mask: Once the tooling operation is complete, it requires only an up and back motion to strip off the used Fret Dressing Mask in just a few moments.

### DETAILED DESCRIPTION: FRET DRESSING MASK, THE TOOL

New tools of any kind must provide the user with an improvement over previous tools and procedures. The development of the Fret Dressing Mask will simplify and expedite the fret filing operation of fretted stringed instruments. The first and primary consideration in developing this tool, is to speed up the production process, thus reducing labor costs. This is accomplished with the Fret Dressing Mask, a tool which is easy to use, quick to apply and remove, provides great precision, protects the expensive wood from damage, and is economical to use at the same time.

Fret Dressing Masks: Fret Dressing Masks are a simple, economical, disposable tool, but instead of a paper backing, are made of vinyl. The difficulty in developing a tool to fit the above requirement, is compounded by the fact that the number, spacing, and size of frets varies from one instrument model to the next. A precision fit to each model is necessary. Without the precision fit, the Fret Dressing Mask would be useless.

The basic design of the Fret Dressing Mask is a vinyl strip 22 inches long tapering from approximately 2¾ inches wide at the top, to approximately 3½ inches wide at the bottom. Slots/windows are cut to fit precisely to the various instruments frets. Twenty to twenty four frets are placed on an instrument neck, the top fret spacing is usually 1¼ inches between frets, growing progressively closer down the neck, ending with the bottom spacing close to 5/16 inch. Spacing of the frets from one instrument model to the next vary slightly (please see—Page 9, FIG. 1A).

Making of the tool: The vinyl from which the Fret Dressing is cut is an adhesive backed material with a protective backing covering the adhesive until removal for installation. During product development, it was determined that a 4 millimeter vinyl is best suited to the Fret Dressing Mask application.

By initially designing the fret dressings in a computer graphics program, the ability to cut the Fret Dressing Mask from existing equipment designed for graphics production was achieved. Then, as orders are received for a specific instrument, the basic dimensions minutely adjusts within the program to the measurements and spacing of the frets on each instrument model. With that flexibility, the basic Fret Dressing Masks can be economically produced to fit specifications as necessary.

A white vinyl is used for the Fret Dressing Masks, though it is not a factor as they can be produced in any color.

### DESCRIPTION OF THE PREFERRED EMBODIMENT

Application of the Fret Dressing Mask takes less than two minutes, and is so simple even a non craftsman can do it. The old time consuming accuracy of fitting tape to each and every fret is gone as the Fret Dressing Mask is precut to register (see Page 10 FIG. 7A). The Luthier simply pulls the paper backing from the dressing, then adheres one end to the front of the neck, the other end swings down, automatically aligning the slots/windows with the respective frets. Once the dressing is positioned at the top, lightly press the dressing with fingers between each fret, firmly adhering the dressing to the wood neck (Page 10 FIG. 7B). The dressing is larger than the neck and is designed to overhang each side and each end for neck protection.

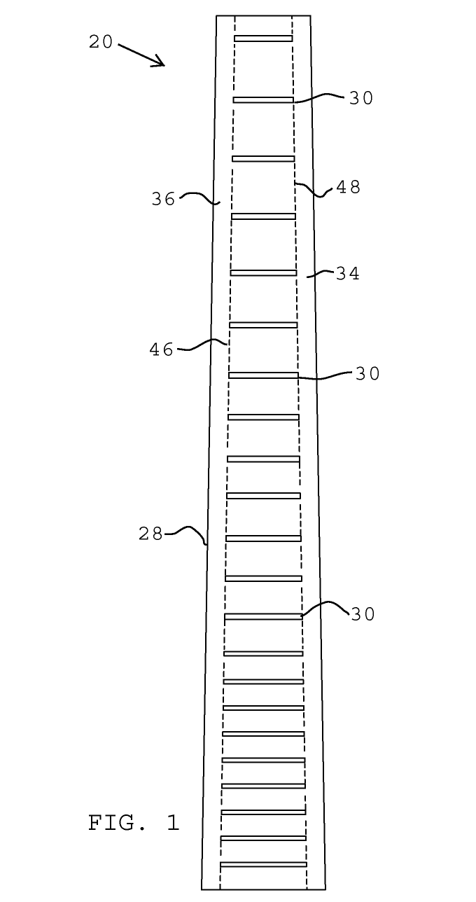

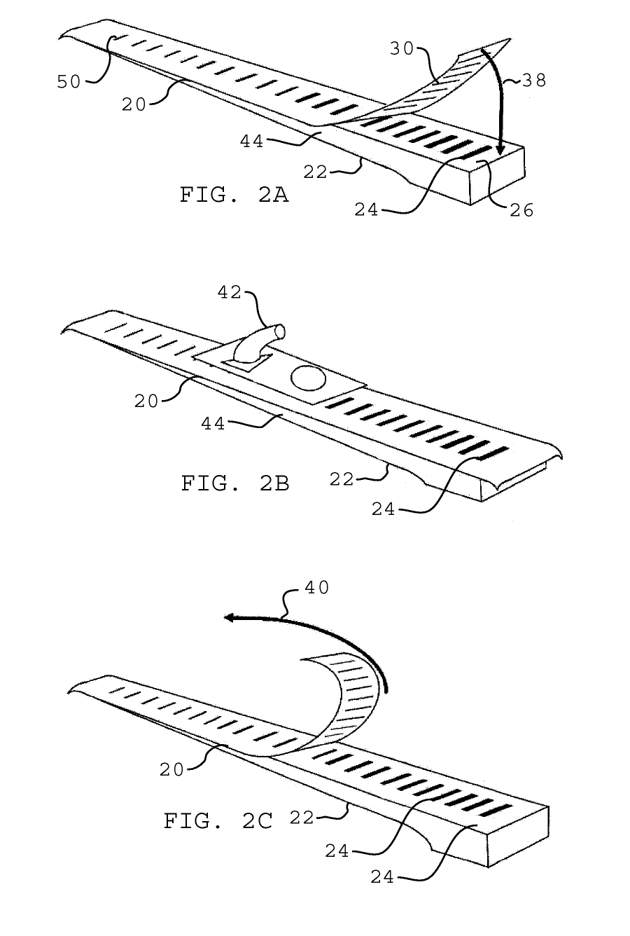

The Luthier then proceeds with the main operation of filling frets. Once completed, removal of the Fret Dressing Mask is simplified compared to the current method of picking pieces of tape from the instrument neck. The Luthier simply grasps one end of the Fret Dressing Mask and lifts it up and back in one motion to remove it (Page 10 FIG. 2C).

Prior to filing of the frets, the old masking process alone has always been a time consuming affair. It has required hand masking of the wood neck between each of the frets with several layers of masking tape. Protection of the wood during the filing process, is paramount to quality neck fabrication. The existing process involves layering of masking tape with precision positioning of a strip of tape against each fret, on each side. That alone amounts to forty or more different applications of tape layered between the frets, so the wood is covered to protect from the filing process. This is an old time honored, time consuming process, which continues in use today.

I have heard of only one other method of covering the neck, which was tried in the past and was a non patented idea. That attempt was a technique, where a thin metal covering was formed to fit the guitar neck and then slots were filed in register with the frets. Though in theory this sounded like a solution, it failed, as it was extremely hard to achieve register with frets. Further, the metal edges were sharp and would cut and scratch the wood neck during the filing operation and, also, would cut the Luthier's fingers. Obviously, it was not a viable solution.

In doing the patent search, I found no patents for a tool to protect instrument necks during filing.

### PATENT SEARCH

Patent Search:

A search was conducted of patented tools, for use in a manner similar to Fret Dressing Masks in the manufacturing of instrument necks. It yielded no previous art as being recorded with the patent office.

Obviously, there are many patents relating to guitar technology, tools of manufacturing, and accessories. The search, starting with the first listed patent relating to fretted stringed instruments in any way, found nothing relating to the procedure to which the Fret Dressing Masks are intended.

In talking to many different manufacturers of instruments, there was only one instance where previous art had been attempted, but proved unsuccessful. Further, there were no records found of a patent for that idea.

1. (canceled)

2. A masking for use with a stringed instrument having a plurality of frets spaced along a top face of a neck, comprising:
a strip of polymer material having a plurality of slots formed therethrough, said slots being sized and positioned complementarily to said frets;
said slots configured to receive said frets when said strip is attached to said neck during manufacture, said frets being substantially exposed and said top face being substantially covered;
whereby said masking substantially protects said neck from damage during a fret filing process.

3. The masking of claim 2 wherein the width of said strip is wider than the width of said neck, providing an overhang on at least one side of said neck.

4. The masking of claim 3 wherein said overhang is configured to be wrapped at least partially around said side of neck, thereby protecting said side from damage.

5. The masking of claim 2 wherein the thickness of said polymer material is sufficiently thick to prevent damage to said neck.

6. The masking of claim 2 wherein the thickness of said polymer material is sufficiently thin to prevent interference with said fret filing process.

7. The masking of claim 2 wherein said masking is configured to be temporarily attached to said neck in preparation for said fret filing process, being removed afterwards.

8. The masking of claim 7 wherein one side of said masking is coated with an adhesive to permit the temporary attachment to at least said front face.

9. The masking of claim 2 wherein said slots vary in length one to the other, corresponding to a varying in length of said frets along said neck.

10. The masking of claim 2 wherein the sizes of said slots are configured to permit the insertion of said frets with substantially no clearance, whereby no portion of said front face is exposed during said fret filing process.

11. The masking of claim 2 wherein said polymer material is vinyl.

12. The masking of claim 11 wherein the thickness of said vinyl is a minimum 4 mm and a maximum of 8 mm.

13. A method for filing a plurality of frets installed along a neck of a stringed instrument, comprising the steps of:
providing a polymer masking having a plurality of slots complementarily configured to receive said plurality of frets;
attaching said polymer masking to said neck, said frets being exposed and a top face of said neck being covered;
filing said exposed frets; and
removing said polymer masking after filing.

14. The method of claim 13 further comprising the step of:
wrapping an overhanging portion of said polymer masking at least partially around said neck before filing.
